(19) United States
(12) Patent Application Publication
(10) Pub. No.: US 2024/0280844 A1
(43) Pub. Date: Aug. 22, 2024

(54) METHOD AND APPARATUS FOR ULTRAFAST SELECTION OF OPTICAL SPECTRUM

(71) Applicant: Soreq Nuclear Research Center, Yavne (IL)

(72) Inventors: Neta Arad-Vosk, Yavne (IL); Bruno Sfez, Yavne (IL)

(73) Assignee: Soreq Nuclear Research Center, Yavne (IL)

(21) Appl. No.: 18/681,149

(22) PCT Filed: Aug. 9, 2022
(86) PCT No.: PCT/IB2022/057421

§ 371 Date: Feb. 5, 2024

Related U.S. Application Data
(60) Provisional application No. 63/232,309, filed on Aug. 12, 2021.

(51) Int. Cl. G02F 1/03; G02B 6/293

(52) U.S. Cl. CPC G02F 1/0311; G02B 6/29395; G02F 2203/055

(57) ABSTRACT

A tunable optical filter includes a dispersive-collimating element, an electro-optical medium apparatus and a focusing-dispersive element such that the dispersive-collimating element assigns each beam wavelength to a particular spatial position, the beams being parallel to each other, the electro-optical medium apparatus changes the polarization state independently for each wavelength, and the focusing-dispersive element recombines the different wavelengths into one single beam.

### FIELD OF THE INVENTION

The present invention relates generally to methods for modifying the spectrum of an optical source in a very fast way.

### BACKGROUND OF THE INVENTION

Selectable bandwidth optical filters are well known. For example, by utilizing multiple liquid crystal variable retarders and polarizers, selectable bandwidth optical filters can switch between wavelengths in the entire visible light spectrum. These filters typically comprise several filter stages placed in optical sequence to produce an overall filter response having a desired free spectral range (FSR) and full-width at half maximum (FWHM).

Current selectable bandwidth optical filters are typically based on liquid crystals with response times of a few hundreds of milliseconds. Other filters are based on moving parts with poor temporal response.

### SUMMARY

The present invention provides methods for modifying the spectrum of an optical source in a very fast way, as is described further below.

In order to modify the spectrum of a polarized light source, light is first spatially dispersed, and then appropriately coupled in an electro-optical material onto which an electric field is applied and finally recombined. The electric field, through the Pockels or Kerr effect, induces a different phase between light polarizations propagating along the two different axes of the electro-optical material, therefore leading to a spatially dependent change of the polarization.

By positioning crossed polarizers before and after the electro-optical medium, a fast tunable shutter and filter is provided. By adequately choosing the amplitude of the electric field or the length of the electro-optic crystal, the medium acts as a quarter or half wave plate for each wavelength. Therefore by turning on or off the electric field, specific light wavelengths can be filtered out respectively in reflection or in transmission.

### BRIEF DESCRIPTION OF THE DRAWINGS

The present invention will be understood and appreciated more fully from the following detailed description taken in conjunction with the drawings in which:

FIG. 1 is a schematic drawing of the electro-optical medium, with electrodes on two opposing faces, such as top and bottom, which provides the spatially controlled electric field.

FIG. 2 is an illustration of a collimated polychromatic light beam 10, which is diffracted by a diffractive element 12, (e.g. prism set or diffraction grating) and is collimated using a cylindrical lens 14. After collimation each wavelength impinges on the electro-optic medium 16 at a different position. The medium 16 acts as a fast tunable wave plate. The beams pass through the medium 16, and a lens 18 and a dispersive or diffractive element 20 recombine the beams.

FIG. 3 is an illustration of a similar setup to FIG. 2, with the addition of crossed polarizers 22 and 24, respectively before diffractive element 12 and after diffractive element 20. The crossed polarizers ensure that only a certain bandwidth will pass the second polarizer.

FIG. 4 is an illustration of a similar set-up as FIG. 2, in which the electro-optic medium 16 is cut to allow a single voltage value (see text below with equation 2). Element 26 is a part that completes the shape of the electro optic medium 16 into a rectangular plate. Element 26 is index-matched to the electro optic material refractive index.

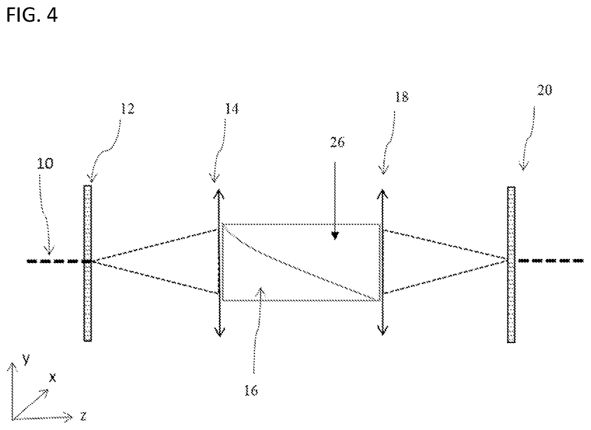

FIG. 5 is an illustration of the shaped electro-optic material 16, element 28 is an index matched transparent material with a near-zero electro-optical coefficient and near-zero chromatic dispersion. Element 30 is the complementary electro-optic material to medium 16. It is from the same material but is not submitted to an electric field.

### DETAILED DESCRIPTION

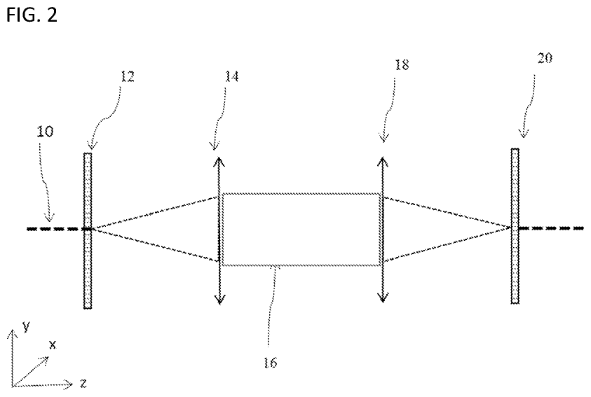

Reference is now made to FIG. 2. Starting with a collimated polychromatic beam 10, light is diffracted by a diffractive element 12, (e.g. prism set or diffraction grating) and is collimated using a cylindrical lens 14. After collimation, each wavelength impinges on the electro optic medium 16 at a different position.

In the electro-optic effect (e.g. Pockels or Kerr effect), an external electric field E produces birefringence in electro-optical medium 16. The birefringence depends on the strength of the electric field. It can be shown that the acquired phase difference between the two components of the beam electric field is given by:

$$Δ ϕ = \frac{π}{λ} {n}^{3} rEx \qquad ( 1 )$$

where λ is the wavelengths, n is the refractive index, x is the path length and r is the Pockels coefficient.

The advantage of using an electro-optic material is that its response time is very fast, down to less than a nanosecond.

Since the wavelengths are spatially separated, by controlling the spatial distribution of the electric field, the birefringence for each wavelength can be controlled so that only a specified bandwidth will experience the designed phase difference between the two components of the beam electric field.

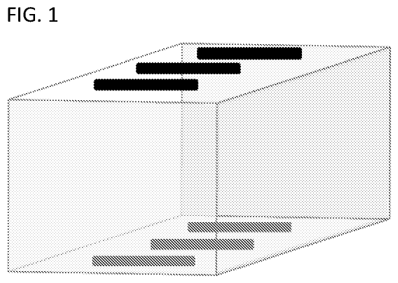

To spatially control the electric field, small electrodes pairs can be deposited (or formed by other methods) on opposing sides (e.g., the top and bottom) of the optical medium (see FIG. 1). Each electrode pair (top and bottom electrode) is connected to a voltage source (or left floating). By modifying the voltage, the spatial distribution of the electric field in the medium is changed.

In a first embodiment, in order to compensate for the wavelength dependence of the birefringence, different voltages can be supplied to each electrode pair (i.e., for each wavelength) so that the birefringence is kept similar.

In the preferred embodiment, the optical medium can be cut to provide an optical path for each wavelength, so that the polarization trajectory along the Poincare sphere is the same for each wavelength. From equation (1) we can calculate the required crystal length, x, for each wavelength:

$$x = Δ {ϕ}_{d} / ( \frac{π}{λ} {n}^{3} rE ) \qquad ( 2 )$$

where Δϕ_{d} is the designed phase difference. Cutting the electro-optical medium, according to (2) enables the use of a single voltage value for all electrodes, which is only turned on or off.

Non-limiting embodiments include a tunable wave plate and a tunable filter.

### Embodiment 1: Tunable Wavelength and Bandwidth Wave Plate

A fast tunable wave plate can be formed in this manner, where the phase difference between the two components of the light electric field is set to the desired value (for example, π for a half wave plate). By setting a suitable voltage between the different electrode pairs the bandwidth and center wavelength can be chosen. After the medium 16 (FIG. 2), a lens 18 and dispersive or diffractive element 20 recombine the beam.

### Embodiment 2: Fast Tunable Shutter or Filter

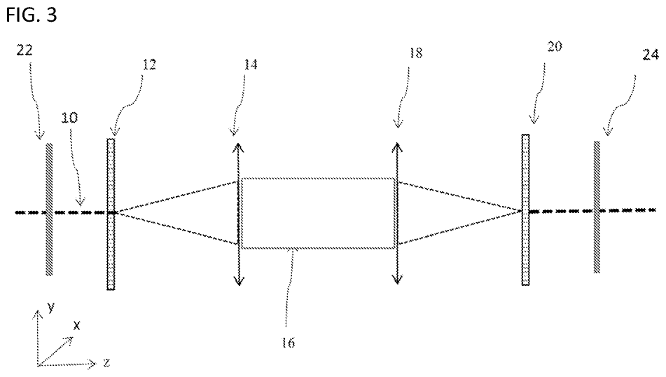

By adding crossed polarizers (two perpendicular linear polarizers) to embodiment 1 (elements no. 22 and 24 in FIG. 3), a fast tunable shutter or filter can be formed, where only wavelengths that experienced a phase difference of π after medium 16, will pass the second polarizer 24.

These embodiments can be implemented according to different configurations:
a. a specially shaped electro-optical medium (as described in the preferred embodiment above) and a single value voltage to all electrodes (that can be selectively turned on or off at each electrode)
b. a rectangular-shaped electro-optical medium, and different voltage values for each electrodes pair, depending on the wavelength
c. a rectangular-shaped electro-optical medium and a single value voltage to all electrodes pairs (this will provide somewhat different birefringence for each wavelength).

In all of these configurations the voltage for each electrode pair can be turned on and off independently.

### Embodiment 3: The Dispersive or Diffractive Element Consists of Gratings or Prisms or Both (for Example—Prisms Pair)

### Embodiment 4: Phase Compensation

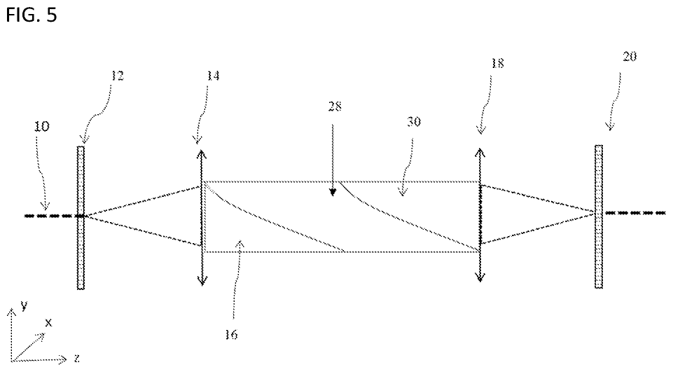

If the optical medium is cut to provide different path lengths for each wavelength (as described above) different phase-shifts will be accumulated for each wavelength. This can be compensated for by filling the part that has been removed from the rectangular plate with a material that has the same refractive index, as shown in FIG. 5 (element 26).

### Embodiment 5: Dispersion Compensation

The previous phase compensation scheme is not sufficient, for example, for femtosecond lasers, where the relative phases of each wavelength component of the pulse are critical. In FIG. 5 a combination allows compensating for dispersion.

Here medium 16 is the cut optical medium, Element 28 is an index matched material with minimal dispersion and element 30 is the complementary of the previous optical medium (meaning that by adjusting the two parts, one obtains a perfect rectangular plate). Medium 16 is subject to the electric field E whereas element 28 is not. The purpose of the element 28 region is to position element 30 for the electric field region so that the role of element 30 is only to compensate for dispersion and phase.

### Embodiment 6: Polarization Distortion at Surfaces

The dispersive elements 12 and 20 generate beams that propagate in different directions (each wavelength corresponds to a different direction). When these beams meet a surface, the beams polarization changes according to Fresnel law (for example, if they meet a surface at Brewster angle, only one polarization component is kept). In order to reduce this distortive effect, several solutions are presented in the invention:
Solution 1: Coating of the surface with a polarization independent antireflection layer (or multilayer) over a large numerical aperture (equal or larger than the beam numerical aperture).
Solution 2: Adding before, after, or both before and after, a birefringent element (phase plate) that is matched to the surface so that it corrects (pre-correction or post-correction or both) the distortive effect. It should be noted that this birefringent element has a variable birefringence (direction and value) along the x axis. However, there is no need for achromatic birefringence, since each value of x corresponds to a specific wavelength.
Solution 3: The distortion in the polarization is a second order effect. Therefore by maintaining a small enough angle all over the propagation length, this effect can be minimized.

1. A tunable optical filter comprising:
a dispersive-collimating element, an electro-optical medium apparatus and a focusing-dispersive element such that said dispersive-collimating element assigns each beam wavelength to a particular spatial position, the beams being parallel to each other, said electro-optical medium apparatus changes the polarization state independently for each wavelength, and said focusing-dispersive element recombines the different wavelengths into one single beam.

2. The tunable optical filter according to claim 1, wherein the electro-optical medium comprises multiple pairs of electrodes that are connected to voltage sources so that an electric field strength is different for each wavelength and a phase difference between the beam electric field components is different for different wavelengths.

3. The tunable optical filter according to claim 1, wherein crossed polarizers are added before and after the dispersive-collimating element.

4. The tunable optical filter according to claim 1, wherein said electro-optical medium is shaped to compensate for a birefringence wavelength dependence, allowing for a single-value voltage source.

5. The tunable optical filter according to claim 4, wherein a shape of the electro-optical material is complemented to a rectangular shape by using a transparent material with no electro-optical effect and index-matched so that beams exit in a direction that is parallel to the impinging beam.

6. The tunable optical filter according to claim 5, wherein the shape of the material is complemented to the rectangular shape by using a complemented part of the same electro-optical material, the result of complementation being a rectangular shape, and distanced from said shaped electro-optical material by a transparent material with near-zero electro-optical coefficient and index-matched to the electro-optical material refractive index, said complemented electro-optical material being located in a region where the electric field is approximately null.

7. The tunable optical filter according to claim 1, wherein said electro-optical medium apparatus is cut at Brewster angle to improve transmission.
